(19) United States
(12) Patent Application Publication
(10) Pub. No.: US 2004/0015484 A1
(43) Pub. Date: Jan. 22, 2004

(54) Client context-aware proxy server system

(76) Inventor: Philippe Debaty, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/198,029

(22) Filed: Jul. 18, 2002

(51) Int. Cl. G06F 17/30

(52) U.S. Cl. 707/3

(57) ABSTRACT

A context-aware proxy server system includes a proxy engine that processes a request from a client system coupled to the proxy server system to retrieve a web page from a remote web server and pass the web page to the client system. A context store is provided to store context information of the client system. A transformation module is coupled to the proxy engine and the context store to add the context information into the web page before the web page is sent to the client system such that services specified in the context information can be readily invoked by the client system via the modified web page. A method of including context information of a client system into a web page sent to the client system is also described.

### BACKGROUND OF THE INVENTION

1. Field of the Invention

The present invention pertains to the Internet. More particularly, this invention relates to a proxy server that adds context information of a client system into web pages to be sent to the client system such that services specified in the context information can be readily invoked by the client system via the modified web pages.

2. Description of the Related Art

At minimum, a World Wide Web (“WWW”) network system typically includes a client system connected to a web server via a gateway system. The web server hosts or contains web pages that can be retrieved by the remote client system using a web browser software. The communication between the web server and the client system follows the client-server model and relies on the Transmission Control Protocol (TCP) for reliable delivery of information. The communication protocol between the client system and the web server can be the HTTP (Hyper Text Transfer Protocol) protocol, which is an open standard protocol.

To reduce delay and network traffic between the web server and the gateway system, a proxy server is provided in the gateway system. The proxy server is used to temporarily cache web pages that have been retrieved from the web server. When a cached web page is again requested either by the same client system or by another client system also connected to the gateway system, the proxy server allows the cached web page to be quickly retrieved and sent to the requesting client system. This is based on the assumption that at least some of the cached web pages will be requested by the same or different client systems at later times, thus reducing delay and network traffic between the web server and the gateway system. In addition, the proxy server is often used as a firewall for security purposes (i.e., to shield from unauthorized external accesses from the global Internet).

The client system can also be referred to as a client device or an access device. The client system can be implemented by a computer system, a PDA (Personal Digital Assistant), or other electronic device with data processing capabilities (e.g., a cell phone or a web TV). This means that the client system can be stationary or mobile. But no matter where it is, a client system is always within its own environment (i.e., personalized environment) which can be defined by the Internet-enabled entities or devices located adjacent to the client system. The entities or devices provide services via the Internet. For example, if the client system is located in an office near an Internet-enabled printer, the personalized environment of the client system may be defined just by the printer. As a further example, when the client system is in a conference room, the personalized environment may be defined by an Internet-enabled projector, an Internet-enabled printer, an Internet-enabled light control, an Internet-enabled room temperature control, and an Internet-enabled speaker, all of which are in the conference room.

The personalized environment of a client system changes when the client system moves to a new location. For example, if the client system is in a family room of a home, its personalized environment may include a TV, a stereo system, a DVD player, a printer, a digital camera, a light control, and a temperature control, each of which is Internet-enabled and in the family room. But when the client system moves to a bedroom of the same home, then the personalized environment of the client system may be changed to only include an Internet-enabled light control in the bedroom. This means that the personalized environment is location-dependent. In other words, a client system may have more than one personalized environment.

The information describing a personalized environment is referred to as the context information. The context information of a personalized environment specifies or describes all Internet-enabled services within the environment. As described above, the Internet-enabled services can be provided by the physical entities/devices adjacent to the client system. These services can therefore be referred to as context-aware services or local services. In addition, the context information may also include location information of the client system, identity information of the client system, and sensor readings information from the environment, etc.

Prior art schemes have been proposed to invoke the context-aware services using the context information. One such prior art scheme is to provide context-aware web sites that store the context information of each client system. In this case, the user first has to log onto the context-aware web sites to get the context information delivered. Such sites, however, are extremely costly and the user is restricted to only a few web sites that have been modified to contain the context information. In other words, the context information is not automatically provided to the user. Moreover, the user must have a different account at each of such sites and most web sites cannot use the user's location information to retrieve the associated context information.

### SUMMARY OF THE INVENTION

One feature of the present invention is to add context information of a client system into web pages sent to the client system.

Another feature of the present invention is to add context information of a client system into web pages sent to the client system such that services described in the context information can be readily invoked by the client system via the modified web pages.

In accordance with one embodiment of the present invention, a context-aware proxy server system is provided that includes a proxy engine that processes a request from a client system coupled to the proxy server system to retrieve a web page from a remote web server, and to pass the web page to the client system. A context store is provided to store context information of the client system. A transformation module is coupled to the proxy engine and the context store to add the context information into the web page before the web page is sent to the client system such that service described in the context information can be readily invoked by the client system via the modified web page.

A method of including context information of a client system into a web page sent to the client system includes the step of storing the context information in a proxy server coupled to the client system. A request from the client system is processed to retrieve the web page from a remote web server. The context information is then added into the web page before the modified web page is sent to the client system such that services specified in the context information can be readily invoked by the client system via the modified web page.

### BRIEF DESCRIPTION OF THE DRAWINGS

FIG. 1 shows a data service network system that includes a context-aware proxy server that implements one embodiment of the present invention.

FIG. 2 shows the structure of the context-aware proxy server of FIG. 1 that includes a proxy engine, a context information store, and a transformation module.

FIG. 3 is a flowchart diagram showing the operational process of the transformation module of FIG. 2.

FIG. 4 shows in a flowchart diagram form the operational process of the proxy engine of FIG. 2.

FIG. 5 schematically illustrates an example of a modified web page by the context-aware proxy server of FIGS. 1-4.

### DETAILED DESCRIPTION OF THE INVENTION

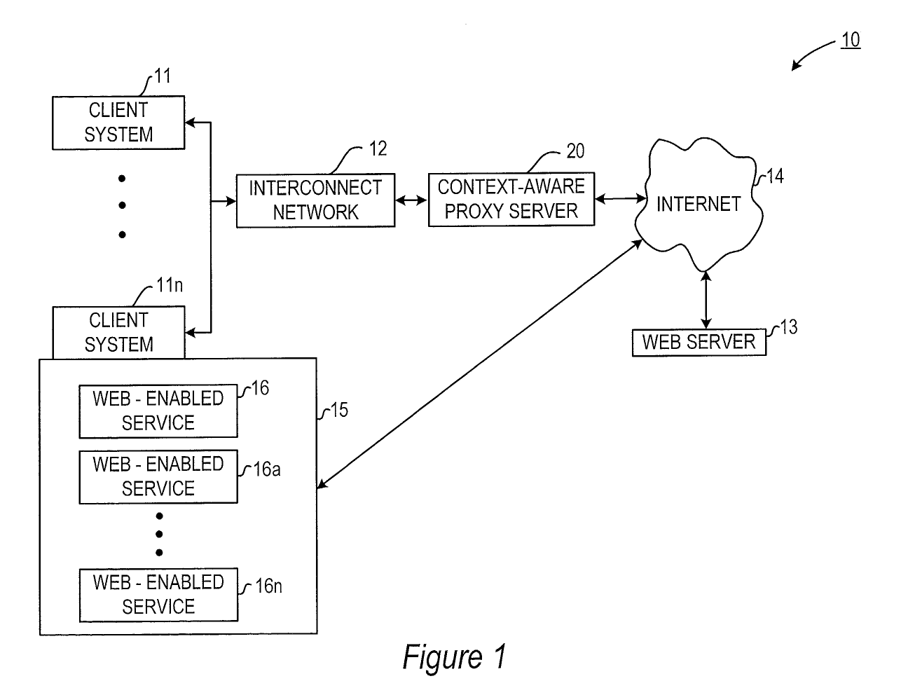

FIG. 1 shows a network system 10 that includes a client context-aware proxy server 20 that implements one embodiment of the present invention. In one embodiment, the network system 10 is a World Wide Web (“WWW”) network system. Alternatively, the network system 10 can be other type of data service network system.

As will be described in more detail below, the client context-aware proxy server 20 seamlessly embeds context information of client systems (e.g., the client systems 11-11n) into arbitrary web pages to be sent to these client systems such that the client systems can invoke their respective context-aware services (e.g., the services 16-16n) within their respective personalized environments (e.g., the environment 15). The context information can be in the form of a single URL (Universal Resource Locator) hyperlink or a context menu having a number of command-like URLs. Such a URL could reference an Internet-enabled device or service within the environment, and hold encoded parameters.

This embedding process is transparent to the users at the client systems 11-11n, and requires no hardware and/or software change to either the client systems that receive the modified web pages, or the web servers that store the web pages before they are modified to include the context information. This arrangement provides personalized web pages to the users at the client systems 11-11n without having to change the structure of either the client systems 11-11n or the web server 13. This means that a user at the requesting client system can get personalized (i.e., context-aware) content from any web server. Additionally, the user's context information is not disclosed to any web server from which the user retrieves a web page. Only the proxy server 20 gets to know the context information of a client system.

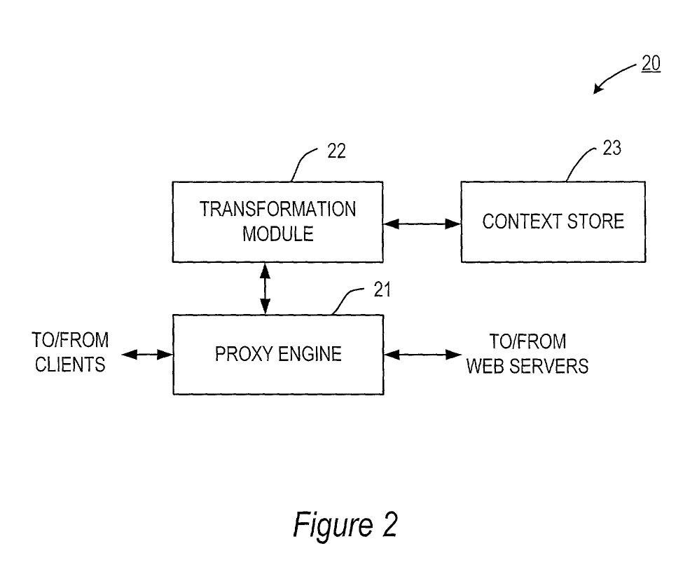

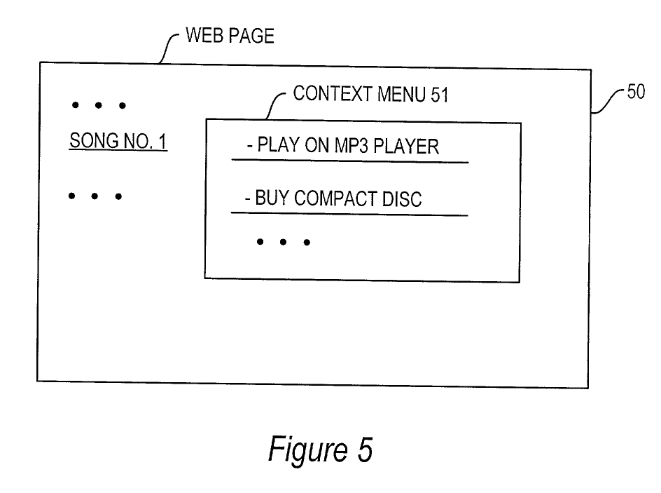

To achieve this, the context-aware proxy server 20 includes a context store 23 (see FIG. 2) that stores context information of each of the client systems connected to the proxy server 20. A proxy engine 21 (see FIG. 2) is used to receive a request from one of the client systems to retrieve a requested web page from a remote web server. In addition, a transformation module 22 (see FIG. 2) is connected between the context store 23 and the proxy engine 21 to (1) retrieve the context information of the requesting client system from the context store 23 and (2) add or include the context information of the requesting client system into the web page that has been retrieved by the proxy engine 21 before the web page is sent to the requesting client system. The context information is added into the web page in the form of, for example, a context menu (e.g., the context menu 51 in FIG. 5) that includes a number of command-like URLs. The structure and operation of the client context-aware proxy server 20 will be described in more detail below, also in conjunction with FIGS. 1-5.

Referring again to FIG. 1, the client context-aware proxy server 20 is placed between the client systems 11-11n and a web server 13 via the Internet 14. The Internet 14 is, in fact, formed by multiple servers (including web servers) connected together via communication networks. The client context-aware proxy server 20 is connected to the client systems 11-11n via an interconnect network 12.

FIG. 1 only shows one web server 13. This is for illustration purpose only. In practice, the client context-aware proxy server 20 can access multiple web servers via the Internet 14. The web server 13 can be implemented using known technology and stores web pages that can be retrieved to any one of the client systems 11-11n upon request. The web server 13 may also be connected to application servers (not shown in FIG. 1) that provide services to the client systems 11-11n via the web server 13.

The client systems 11-1n are connected to the proxy server 20 via an interconnect network 12. The interconnect network 12 can be any known network, such as Ethernet, ISDN (Integrated Services Digital Network), T-1 or T-3 link, FDDI (Fiber Distributed Data Network), cable or wireless network or telephone line network.

Each of the client systems 11-11n can be a computer system or other electronic device with a web browser software (not shown). If a client system is a computer system, it can be a PDA (Personal Digital Assistant), a notebook computer, a mini-computer, a desktop computer, a workstation computer, a super computer, or a server computer. If a client system is implemented by an electronic device, the electronic device can be a cellular phone, a pager, a watch, or a digital camera.

The browser software in each of the client systems 11-11n in sends access requests to and receive responses from the remote web server 13 via the proxy server 20. This allows its user (i.e., a person) to access the contents hosted in the remote web server 13.

The communication among various systems within the network system 10 is conducted using a predetermined open-standard communication protocol for Internet communications. In one embodiment, the protocol is the HTTP protocol.

The proxy server 20 functions as an intermediary between the client systems 11-11n and the web server 13. The proxy server 20 receives requests from the client systems 11-11n. The proxy server 20 also contacts the remote web server 13 to retrieve any requested web pages based on the requests it received from the client systems 11-11n. In addition, the proxy server 20 temporarily caches web pages that have been retrieved from the web server 13. When a cached web page is again requested either by the same client system or by another client system, the proxy server 20 allows the cached web page to be quickly retrieved and sent to the requesting client system. In addition, the proxy server 20 is also used as a firewall for security purposes (i.e., to shield the client systems 11-11n from unauthorized external accesses via the Internet 14).

As can be seen from FIG. 1, each of the client systems 11-11n includes at least one personalized environment. FIG. 1 only shows one such environment 15 for the client system 11n for illustration purpose.

The personalized environment 15 is defined to include a number of web-enabled services 16-16n. Some of these services 16-16n can be provide by web-enabled physical means adjacent to the client system 11n. Some of the services 16-16n can also be provided by mechanism not adjacent to the client system 11n. For example, if the client system 11n is located in an office near an Internet-enabled printer, one of the web-enabled services 16-16n may be provided by the Internet-enabled printer while another one of the web-enabled services 16-16n is provided by a remote e-commerce service (e.g., on-line ordering or banking) server. As a further example, if the client system 11n is in a conference room, some of the web-enabled services 16-16n of the personalized environment 15 may be provided by an Internet-enabled projector, an Internet-enabled printer, an Internet-enabled light control, an Internet-enabled room temperature control, and an Internet-enabled speaker, all of which are in the conference room.

The personalized environment 15 changes when its associated client system 11n moves to a new location. In other words, the client system 11n may have more than one personalized environment. For example, if the client system 11n is in a family room of a home, some of the web-enabled services 16-16n of the personalized environment 15 may be provided by a TV, a stereo system, a DVD player, a printer, a digital camera, a light control, and a temperature control, each of which is Internet-enabled. But when the client system 11n moves to a bedroom of the same home, then the personalized environment 15 may be changed to only include an Internet-enabled light control in the bedroom.

The information describing a personalized environment is referred to as the context information. The context information of a personalized environment specifies or describes all Internet-enabled services within the environment. In addition, the context information may also include location information of the client system, identity information of the client system, and sensor readings information from the environment, etc. The context information can be in the form of a single URL hyperlink or a context menu of a number of command-like URLs. Such a URL could reference an Internet-enabled device or service within the environment, and hold encoded parameters. Moreover, the context information may specify preferences of the user of the client system.

There are many ways to define or discover the personalized environment 15. One way is to have all the services wanting to be included in the personalized environment 15 associate its service with the personalized environment 15 in the proxy server 20. Another way is to have each client system or the proxy server 20 to discover the personalized environment of each of the client systems 11-11n. Any known discovery mechanism can be used for the discovery.

The proxy server 20 stores the context information of each personalized environment of each of the client systems 11-11n, thus becoming the client context-aware proxy server. In accordance with one embodiment of the present invention, the proxy server 20 seamlessly embeds the context information of a client system (e.g., the client system 11n) into arbitrary web pages to be sent to the client systems 11-11n.

Using the client-specific context information and the content of a retrieved web page, the proxy server 20 adds or includes command-like URLs at appropriate places or locations within the web page. Each location within the web page may be added with one command-like URL or a context menu having a number of command-like URLs. For example, when the web page contains a hyperlink of a MP3 file of a song, the proxy server 20 can place, next to the hyperlink of the file, a URL of a local web-enabled MP3 player with a user interface that allows the user to input the user preferred playing parameters (e.g., volume). When the user clicks the URL of the MP3 player, the song can be played at the user's preferred loudness on the local web-enabled MP3 player. In addition, the URL can be replaced with a context menu of a number command-like URLs. For example, the context menu may reference a web-enabled music playing service provided by a MP3 player, a web-enabled on-line ordering service (provided by a remote e-commerce server) to allow the user to order a CD that contains the song, or to order to the MP3 file of the song. Each command-like URL is a location-aware, and URL-dependent command. Some of the command-like URLs can also be of MIME-type. This means that if a document linked by a hyperlink in a web page is a MIME-type document, the MIME-type document can be retrieved and used to determine what local device or service can process this document. For example, an MP3 file (of MIME-type audio/mpeg) can be processed by a local MP3 player but not by a local printer.

This dramatically enhances the capabilities of the web browser of the client system that finally receives the modified web page because the user can now simply click on the added URLs to invoke the respective context-aware services (e.g., the services 16-16n) within their respective personalized environments (e.g., the environment 15). As described above, the embedding process is transparent to the users at the client systems 11-11n, and requires no hardware and/or software change to either the client systems that receive the modified web pages, or the web servers that store the web pages before they are modified to include the context information. This arrangement provides personalized web pages to the users at the client systems 11-11n without having to change the structure of either the client systems 11-11n or the remote web servers (e.g., the web server 13). FIG. 2 shows in more detail the structure and the operation of the proxy server 20, which will be described in more detail below.

As can be seen from FIG. 2, the proxy server 20 includes a proxy engine 21, a context store 23, and a transformation module 22. The proxy engine 21 is used to perform the main function of the proxy server 20. This means that the proxy engine 21 receives requests from the client systems 11-11n (see FIG. 1). This also means that the proxy engine 21, processes each of the requests received to access, if necessary, remote web content servers (e.g., the web server 13 of FIG. 1) for the requested content. The proxy engine 21 then sends the retrieved web page to the transformation module 22 for adding the context information to the web pages. Once the proxy engine 21 receives the modified web page, it then sends the modified web page to the requesting client system.

The transformation module 22 and the context store 23 implement one embodiment of the present invention. The context store 23 is used to store the context information of all the personalized environments of the client systems 11-11n. This means that the context store 23 stores the context information of each of the client systems 11-11n (FIG. 2). The context store 23 is connected to the transformation module 22.

The transformation module 22 is connected to the proxy engine 21. When the transformation module 22 receives a web page to be sent to a requesting client system, the transformation module 22 determines the identity and location of the requesting client system (e.g., from the destination IP address contained in the web page). The transformation module 22 then uses the identity and location of the client system to access the context store 23 for the corresponding context information. Once the corresponding context information of the requesting client system is retrieved from the context store 23, the transformation module 22 adds URLs or context menus at appropriate locations (e.g., next or adjacent to the content item) within the web page such that the web page becomes modified web page. FIG. 5 shows one such modified web page 50. As can be seen from FIG. 5, the modified web page 50 includes a context menu 51 that includes a number of command-like URLs.

Referring back to FIG. 2, the transformation module 22 embeds the context information using known web page construction means. The transformation module 23 then sends the modified web page to the proxy engine 21. The proxy engine 21 then returns the modified web page to the requesting client system. The user at the requesting client system can view the modified web page, and can click on the embedded URLs in the web page to invoke web-enabled services provided by local or remote Internet-enabled devices.

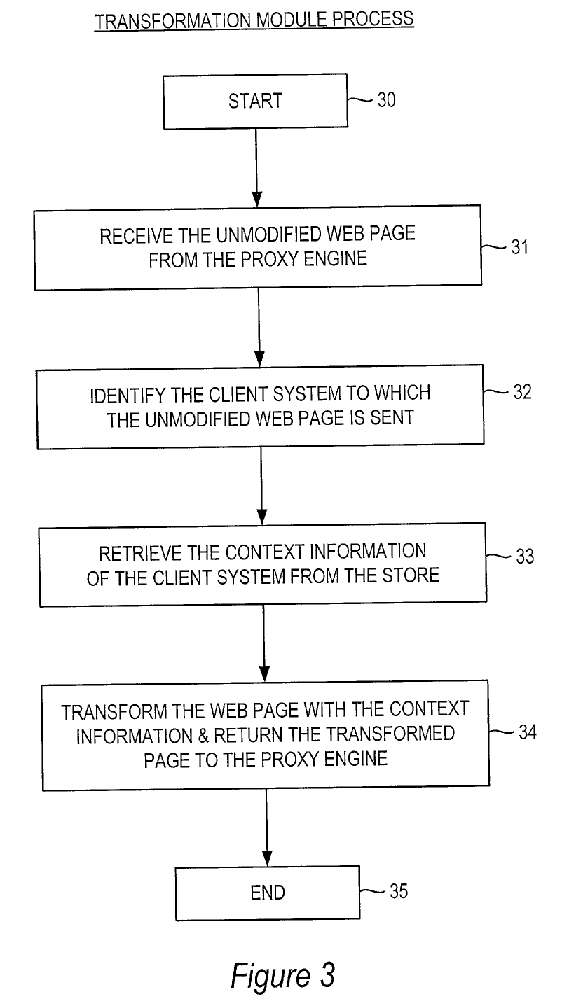

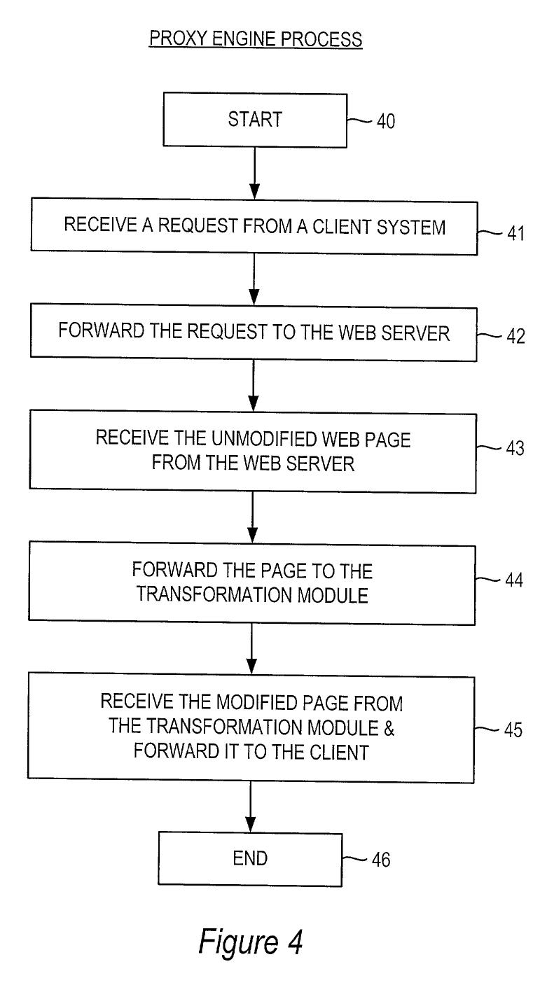

In addition, the proxy engine 21 includes a cache (not shown in FIG. 2) that temporarily caches web pages that have been retrieved from the web server 13 (see FIG. 1). In this case, the cached web pages are unmodified web pages. This means that each of the cached web pages does not contain any context information for any of the client systems 11-11n. The cache is provided to reduce delay and network traffic between the proxy server 20 and the web server 13. When a cached web page is again requested either by the same client system or by another client system also connected to the proxy server 20, the cache allows the cached web page to be quickly retrieved and sent to the requesting client system. The transformation module 22 is described in more detail below, also in conjunction with FIG. 3. The proxy engine 21 is described in more detail below, also in conjunction with FIG. 4.

Referring to FIG. 3, the process of the transformation module 22 of FIG. 2 starts at the step 30. At the step 31, the transformation module 22 receives the unmodified web page from the proxy engine 21 (see FIG. 2). As described above, this unmodified web page is retrieved by the proxy engine 21 from the remote web server 13 (see FIG. 1) in response to a request from the client system 11n (see FIG. 1).

At the step 32, the transformation module 22 determines the identity of the requesting client system. At the step 33, the transformation module 22 uses the determined identity to retrieve the corresponding context information of the requesting client system from the context store 23 (see FIG. 2). At the step 34, the transformation module 22 transforms or modified the unmodified web page with the context information. This means that the transformation module 22 adds the context information into the unmodified web page. The transformation can be done using any known mechanism.

The modified or transformed web page is then returned to the proxy engine 21. The process then ends at the step 35.

Referring to FIG. 4, the process of the proxy engine 21 of FIG. 2 starts at the step 40. At the step 41, the proxy engine 21 receives a request from a client system for a specified web page. At the step 42, the proxy engine 21 forwards the request to the remote web server after having checked that its local cache does not contain the requested web page. If the local cache contains the requested web page, the proxy engine 21 does not forward the request to the remote web server at the step 42. Instead, the proxy engine 21 retrieves the requested web page from the local cache at the step 42.

At the step 43, the proxy engine 21 receives the requested and unmodified web page (either from the local cache of the proxy server or from the remote web server). At the step 44, the proxy engine 21 forwards the unmodified web page to the transformation module 22 such that the context information of the client system can be added into the unmodified web page by the transformation module 22, as described above in accordance with one embodiment of the present invention.

The proxy engine 21 then receives the modified web page at the step 45. Then the proxy engine 21 forwards the modified web page to the requesting client system. The process then ends at the step 46.

In the foregoing specification, the invention has been described with reference to specific embodiments thereof. The specification and drawings should, however, be regarded in an illustrative rather than a restrictive sense.

What is claimed is:

1. A context-aware proxy server system, comprising
a proxy engine that processes a request from a client system coupled to the proxy server system to retrieve a web page from a remote web server and pass the web page to the client system;
a context store that stores context information of the client system;
a transformation module coupled to the proxy engine and the context store to add the context information into the web page before the web page is sent to the client system such that services specified in the context information can be readily invoked by the client system via the modified web page.

2. The proxy server system of claim 1, wherein the context information of the client system specifies web-enabled services available to the client system.

3. The proxy server system of claim 2, wherein the context information specifies each of the web-enabled services in the form of a command-like URL (Universal Resource Locator).

4. The proxy server system of claim 2, wherein the transformation module adds the context information into the web page by creating and embedding a context-menu directly in the web page adjacent to a content item, wherein the context-menu includes a list of URL commands specifying a plurality of web-enabled services.

5. The proxy server system of claim 4, wherein each of the URL commands is a location-aware, and URL-dependent command.

6. The proxy server system of claim 1, wherein the context information of the client system specifies web-enabled services offered by physical devices adjacent to the client system.

7. The proxy server system of claim 1, further comprising a plurality of client systems coupled to the proxy server system, wherein the context store stores the context information of each personalized environment of each of the client systems and the transformation module also transforms the web pages sent to these client systems by adding their corresponding context information into the web pages.

8. The proxy server system of claim 7, wherein each of the client systems can be stationary or mobile.

9. A method of including context information of a client system into a web page sent to the client system, comprising
storing the context information in a proxy server coupled to the client system;
processing a request from the client system to retrieve the web page from a remote web server;
adding the context information into the web page before the modified web page is sent to the client system such that services specified in the context information and available to the client system can be readily invoked via the modified web page.

10. The method of claim 9, further comprising the step of sending the modified web page to the client system.

11. The method of claim 9, wherein the context information specifies web-enabled services available to the client system.

12. The method of claim 11, wherein the context information specifies each of the web-enabled services in the form of a command-like URL (Universal Resource Locator).

13. The method of claim 11, wherein the step of adding the context information further comprising
creating a context-menu that includes a list of URL commands specifying a plurality of web-enabled services;
embedding the context-menu directly in the web page adjacent to a content item.

14. The method of claim 13, wherein each of the URL commands is a location-aware, and URL-dependent command.
